(19) United States
(12) Patent Application Publication
(10) Pub. No.: US 2007/0192720 A1
(43) Pub. Date: Aug. 16, 2007

(54) Correlation rule builder

(76) Inventors: Marshal Alsup, Liberty Lake, WA (US); Greg Beyl, Spokane Valley, WA (US); Michael Maloof, Liberty Lake, WA (US)

Correspondence Address: TECHNOLOGY LAW GROUP, LLC, 8950 W. EMERALD STREET STE. 198, BOISE, ID, 83704, US

(21) Appl. No.: 11/354,479

(22) Filed: Feb. 14, 2006

(51) Int. Cl. G06F 3/00; G06F 9/00

(52) U.S. Cl. 715/769

(57) ABSTRACT

A correlation rule builder is disclosed which displays a graphical user interface that enables a user to construct rules, the program causing a computer to perform actions based on the rules. The interface allows a user to construct the rules by dragging-and-dropping objects from an object chooser panel and an expression object menu bar onto an expression panel. The objects include alerts, logical operators for the rules, and actions. A correlation box inside the expression panel allows the user to create expressions which are related by operators such as AND and OR; the correlated expressions must be satisfied for the chosen actions to occur. The rule builder also allows a user to create groups of expressions within the correlation box; the expressions within each group may be related by operators such as AND and OR, and the groups may be related to each other by operators such as AND and OR.

### BACKGROUND

The present application relates to constructing multiple event correlation systems for computers. More specifically, the present application relates to programs that enable a user to construct a multiple event correlation system using a graphical user interface.

Computers use multiple event correlation systems to look for patterns of behavior by evaluating discrete elements from distinct events to uncover significant relationships. Increasing the number of evaluated events and related elements increases the likelihood that a target pattern of behavior will be detected, but can also add exponential complexity to the relationships. To be effective, multiple event correlation systems should be able to construct complex, multi-dimensional correlation rules to detect significant patterns of behavior. Similarly, real-time event analysis and display systems should distinguish between significant and insignificant events. It is often desirable to build filtering rules quickly because the detection environment can change.

Traditional event modeling and filter techniques make it tedious and time consuming to build multiple event correlation systems and event filters. Existing techniques rely heavily on text-based data entry, extensive lists of correlation elements, rudimentary evaluation precedence, and event relationship metaphors such as nested parentheses. To minimize complexity, these systems often place arbitrary limits on the number and type of data elements or fields that can be used in the correlation or filter rules, and rigidly enforce linear or static evaluation paths.

Where graphical interfaces have been used, they typically utilize multi-state, banded, tabbed, or wizard-like rule and filter construction models. These interfaces attempt to minimize the complexity by breaking the process into individual components and associated shapes. These interfaces produce multiple event correlations and event filters, but are only marginal improvements over pure text-based systems because the multi-step process involved still requires considerable time and effort. Also, the results suffer from significant limitations imposed by the rigidity of their designs that allow for only a fixed set of combinatorial possibilities.

Existing graphical design approaches are further hampered by the fact that the relationship between the various elements cannot be seen or manipulated; in many cases, the process is entirely linear, and subsequent steps in the process can be completed only after previous elements have been defined. FIG. 1 shows a prior art graphical interface used for rule construction. It breaks the rule elements into distinct steps, and the individual steps are largely text and list-based elements.

### SUMMARY

The above-mentioned drawbacks associated with existing computer rule builders are addressed by embodiments of the present application, which will be understood by reading and studying the following specification.

In one embodiment, a method for constructing a correlation rule on a computer comprises viewing a graphical user interface comprising an expression panel, an object chooser panel, and an expression object menu bar. The expression panel comprises an action box and a correlation box including a left field and an operator icon. The method further comprises selecting one or more alert events by dragging and dropping the selected alert event(s) from the object chooser panel to the left field of the correlation box and selecting an operator by clicking on the operator icon of the correlation box. The method further comprises selecting one or more actions to be performed by the correlation rule by dragging and dropping the selected action(s) from the object chooser panel to the action box of the expression panel.

In another embodiment, a correlation rule builder comprises an object chooser panel displayed via a graphical user interface, the object chooser panel comprising a plurality of alert events, and an expression object menu bar displayed via the graphical user interface, the expression object menu bar comprising a plurality of relational terms. The correlation rule builder further comprises an expression panel displayed via the graphical user interface. The expression panel comprises an action box and a correlation box including a left field and an operator icon. The graphical user interface is configured to enable a user to construct correlation rules by dragging and dropping alert events from the object chooser panel to the left field of the correlation box and by dragging and dropping actions from the object chooser panel to the expression panel.

These and other embodiments of the present application will be discussed more fully in the detailed description. The features, functions, and advantages can be achieved independently in various embodiments of the present application, or may be combined in yet other embodiments.

### BRIEF DESCRIPTION OF THE DRAWINGS

FIG. 1 shows a prior art filter rule construction interface.

FIG. 2 is a block diagram showing five components of a rule builder.

FIG. 3 is a block diagram showing an expression panel and expression object menu bar.

FIG. 4A is a block diagram showing an expression panel, undo/redo component, and undo/redo panel.

FIG. 4B is a block diagram showing an undo stack listener.

FIG. 5 shows a single-pane construction work surface used to construct rules in some embodiments of the present application.

FIG. 6 shows an embodiment of the correlation box, which is a component of the work surface used to construct rules.

FIG. 7 shows another embodiment of the correlation box.

FIG. 8 shows another embodiment of the correlation box.

FIG. 9 shows an embodiment of the correlation box with two groups nested inside another group.

FIG. 10 shows an embodiment of the correlation box showing statements of equality between the alert fields in the left field and the association fields in the right field.

FIG. 11 shows an embodiment of the lifespan frame that can substitute for the correlation time portion of the correlation box.

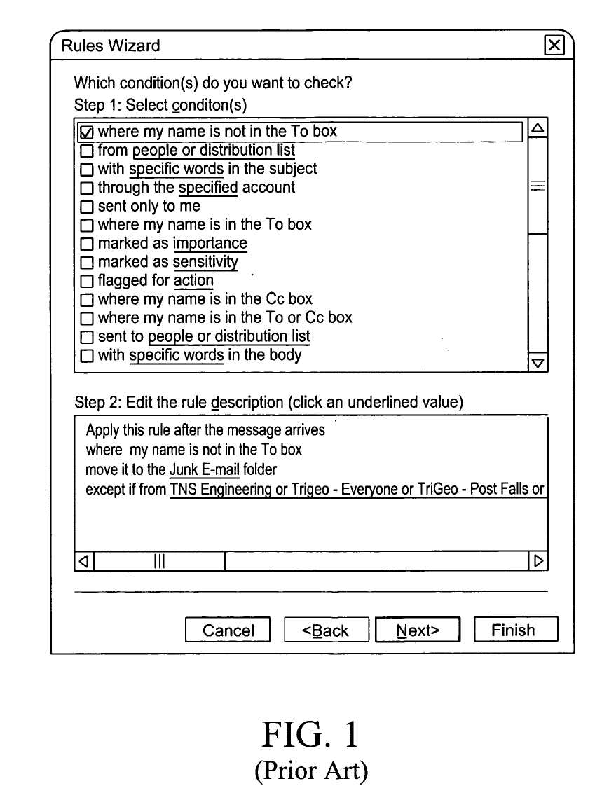

Like reference numbers and designations in the various drawings indicate like elements.

### DETAILED DESCRIPTION

In the following detailed description, reference is made to the accompanying drawings that form a part hereof, and in which is shown by way of illustration specific illustrative embodiments in which the invention may be practiced. These embodiments are described in sufficient detail to enable those skilled in the art to practice the invention, and it is to be understood that other embodiments may be utilized and that various changes may be made without departing from the spirit and scope of the present invention. The following detailed description is, therefore, not to be taken in a limiting sense.

The present application describes a graphical user interface which may be used to construct filter rules, or correlate events and take associated actions. In some embodiments, the described system includes instructions for executing the correlation or filter rules and actions. The rule builder may reside on a computer using the Windows, Linux or Unix operating systems. The user can create custom rules, as described below, use rules that are included in a provided software package, or clone and modify rules included in the software package. Cloning a rule makes a copy of the rule so that changes will not affect the original rule.

In some embodiments, the system described herein can operate independently of the specific event correlation engine used by the computer. This independence is enabled by the system's use of an XML-based data structure that encapsulates both the event correlation rule and the visual presentation of the event correlation rule. While the visual environment of one embodiment comprises building blocks and relationship components that are focused on event correlation to maintain network security, these building blocks could be replaced with other building blocks to construct correlation and filter rules for any other event-driven system.

In some embodiments, the rules built using the systems and methods described herein possess unique characteristics such as multi-vector analysis, where non-linear correlations can be modeled. Hierarchical groups of events with associated evaluation logic and independent event thresholds can also be constructed and visualized.

The graphical drag-and-drop interface used in embodiments of the present application is a comfortable model which enables users to quickly learn how to use and understand the interface. This interface makes it easy to construct multiple event correlation and event filtering rules. The visual construction framework that includes the event correlation building blocks (alert fields and expressions) minimizes the learning curve and enables users to quickly construct high quality rules.

Block Diagrams of Rule Builder

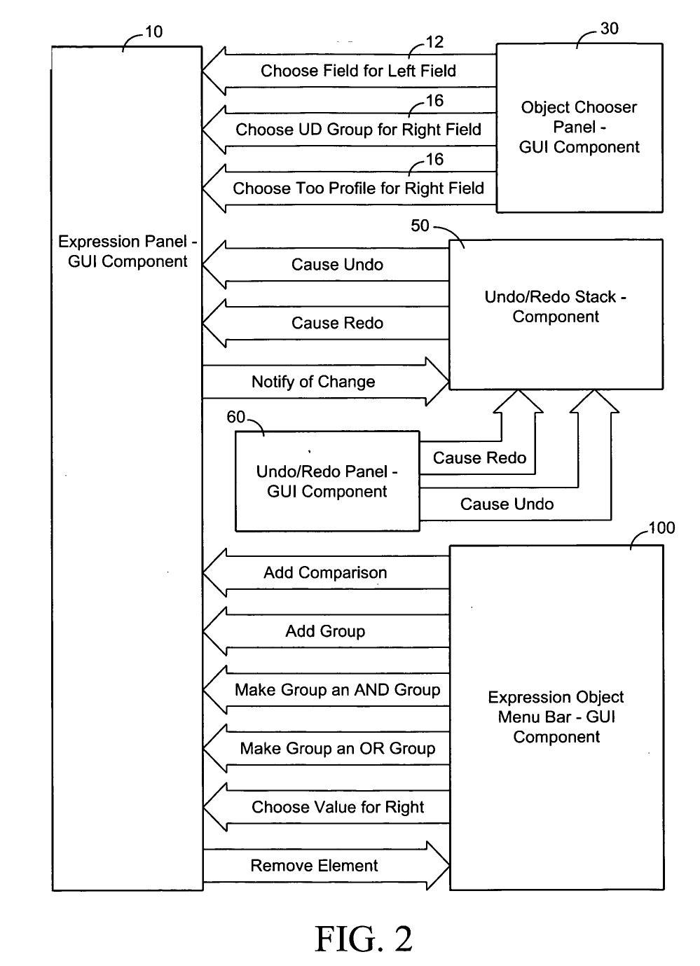

FIGS. 2-4 are top-level block diagrams showing the relationships between certain components of the rule builder 5. As shown in FIG. 2, the rule builder 5 comprises an expression panel 10, an object chooser panel 30, an undo/redo component 50, and an expression object menu bar 100. FIG. 2 shows the relationship between the expression panel 10, the object chooser panel 30, the expression object menu bar 100, and the undo/redo component 50 and undo/redo panel 60.

The term “component” as used herein, may refer to any combination of software, firmware, or hardware used to perform the specified function or functions. It is contemplated that the functions performed by the components described herein may be embodied within either a greater or lesser number of components than is described in the accompanying text. For instance, a single function may be carried out through the operation of multiple components, or more than one function may be performed by the same component. The described components may be implemented as hardware, software, firmware or any combination thereof. Additionally, the described components may reside at different locations connected through a wired or wireless telecommunications network, or the Internet.

As shown in FIG. 2, the object chooser panel 30 is used to choose fields for the left field 12 of the correlation box 11 (which is part of the expression panel 10), to choose user-defined groups for the right field 16, and to choose tool profiles for the right field 16.

The expression object menu bar 100 may be used to add comparisons or include/exclude buttons 19, to add groups 18, to turn groups into AND groups, to turn groups into OR groups, to choose values for the right field 16 of the correlation box, or to remove objects from the expression panel 10.

The undo/redo component 50 comprises an undo stack 51 and a redo stack 53. In operation, the undo stack 51 stores actions that have taken place on the expression panel 10 after being notified of the change by the expression panel 10. When the user clicks the undo button 62, the rule builder 5 will undo the last action that has occurred in the expression panel 10, and store that action in the redo stack 53. When the user clicks the redo button 64, the rule builder 5 will redo in the expression panel 10 the last action stored in the redo stack 53, and store that action in the undo stack 51.

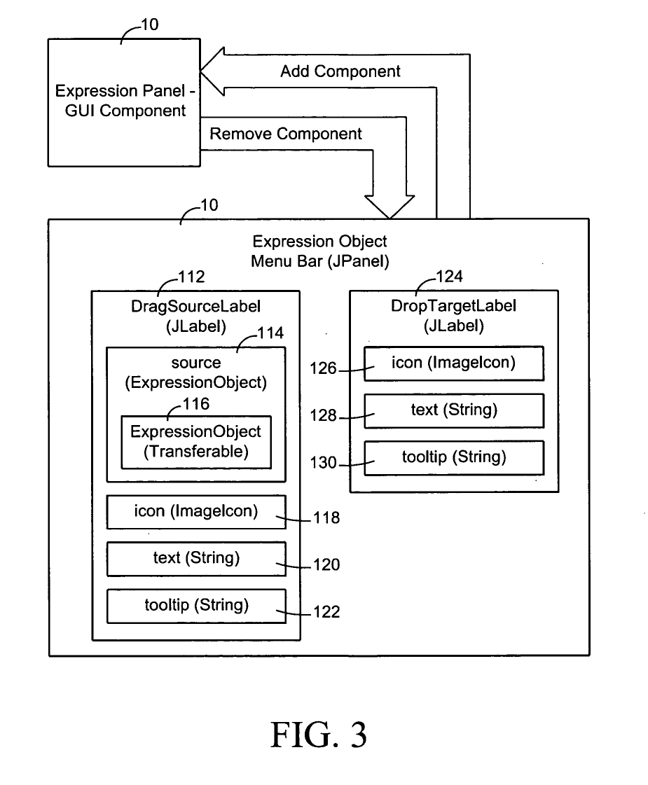

FIG. 3 includes an object diagram of the expression object menu bar 100. The expression object menu bar 100 comprises a panel for holding the label representations of specific expression objects. Two interfaces define objects in the expression object menu bar 100. The first interface, the DragSourceLabel 112, comprises a visual representation of the drag source object. The DragSourceLabel 112 implements DragGestureListener and DragSourceListener and their respective methods, and includes as fields a source expression object 114, an icon 120, text 120, and a tooltip 122. The source expression object 114 is the source object that is to be dragged from the expression object menu bar 100 and dropped into the expression panel 10. The source expression object 114 includes a transferable expression object, which is the base object that is dropped into the expression panel 10. The icon 118 and text 120 are displayed in the label of each button in the expression object menu bar 100, and the tooltip 122 is displayed when the cursor hovers over a button in the expression object menu bar 100.

The second interface, DropTargetLabel 124, comprises a visual representation of a drop source object. The DropTargetLabel 124 can be used as a trash component, and implements DropTargetListener and its methods. The DropTargetLabel 124 includes as fields an icon 126 and text 128 shown in the label, and a tooltip 130 which is displayed when the cursor hovers over the DropTargetLabel 124.

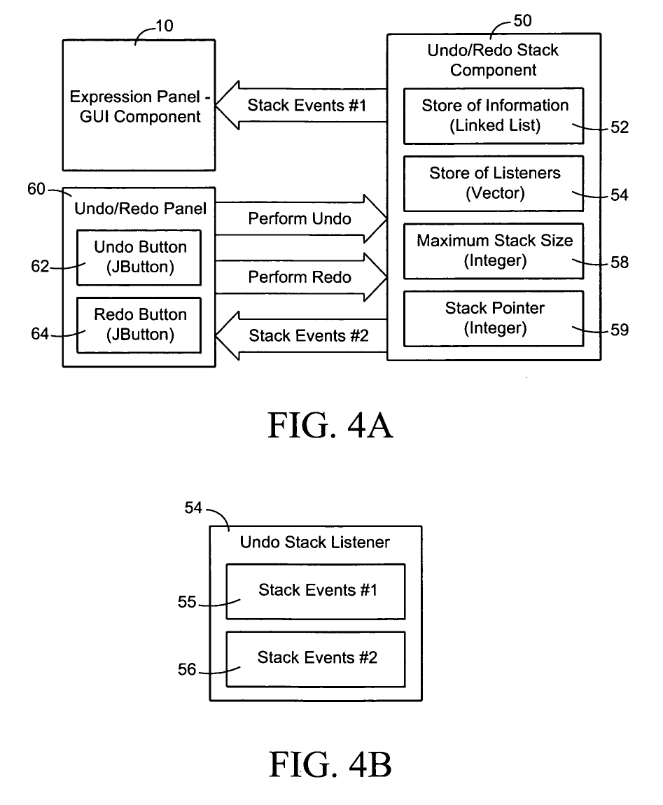

FIG. 4A is a block diagram showing the interaction between the expression panel 10, the undo/redo component 50, and the undo/redo panel 60. In some embodiments, the undo/redo component 50 actually stores undo/redo data, and the undo/redo panel 60 comprises a graphical component which interacts with the user. The undo/redo component 50 includes a store of information 52, a store of listeners 54, a maximum stack size 58, and a stack pointer 59. The store of information 52 stores information regarding past actions in an undo stack 51 and a redo stack 53. The store of listeners 54 includes a collection of components that are notified when the undo/redo component 50 or stack pointer 59 changes, such as when an item is added to the undo stack 51, when an undo is to be performed, when a redo is to be performed, and when the maximum stack size changes. In an alternative embodiment, the store of information 52 does not include a redo stack separate from the undo stack; instead, the store of information 52 includes a single stack, which stores both undo objects and redo objects. In this embodiment, the rule builder 5 can distinguish between undo objects and redo objects stored in the one stack.

FIG. 4B shows two possible stacks of events stored in the undo stack listener 54. A first stack of events 55, labeled Stack Events #1, is listened to by the undo stack listener 54. The first stack of events 55 could include an undo event and a redo event. When executed, an undo event causes the expression panel 10 to grab the current undo object from the undo stack 51. Similarly, a redo event, when executed, causes the expression panel 10 to grab the current redo object from the redo stack 53.

A second stack of events 56, labeled Stack Events #2 in the arrow pointing toward the undo/redo panel 60, is listened to by the undo stack listener 54, and could include an undo event, a redo event, a push event, and a maximum size change event. When executed, an undo event causes the undo/redo panel 60 to check whether an undo or redo is possible and adjust the enabled states of the undo button 62 and redo button 64 accordingly. Similarly, a redo event, when executed, causes the undo/redo panel 60 to again check whether an undo or redo is possible and adjust the enabled states of the undo button 62 and redo button 64 accordingly. A push event, in which data are added to the undo/redo component 50, would cause the undo/redo panel 60 to check whether an undo or redo is possible, and adjust the enabled states of the undo button 62 and redo button 64 accordingly. The maximum size change event can change the maximum number of events stored in the undo/redo component 50. The undo button 62 and redo button 64 are enabled only when an undo or a redo are enabled.

The undo/redo panel 60 includes the undo button 62 and redo button 64. When clicked, the undo button 62 performs an undo event if an undo object is stored in the undo stack 51. Similarly, the redo button 64, when clicked, performs a redo event if a redo object is stored in the redo stack.

Rule Builder Interface

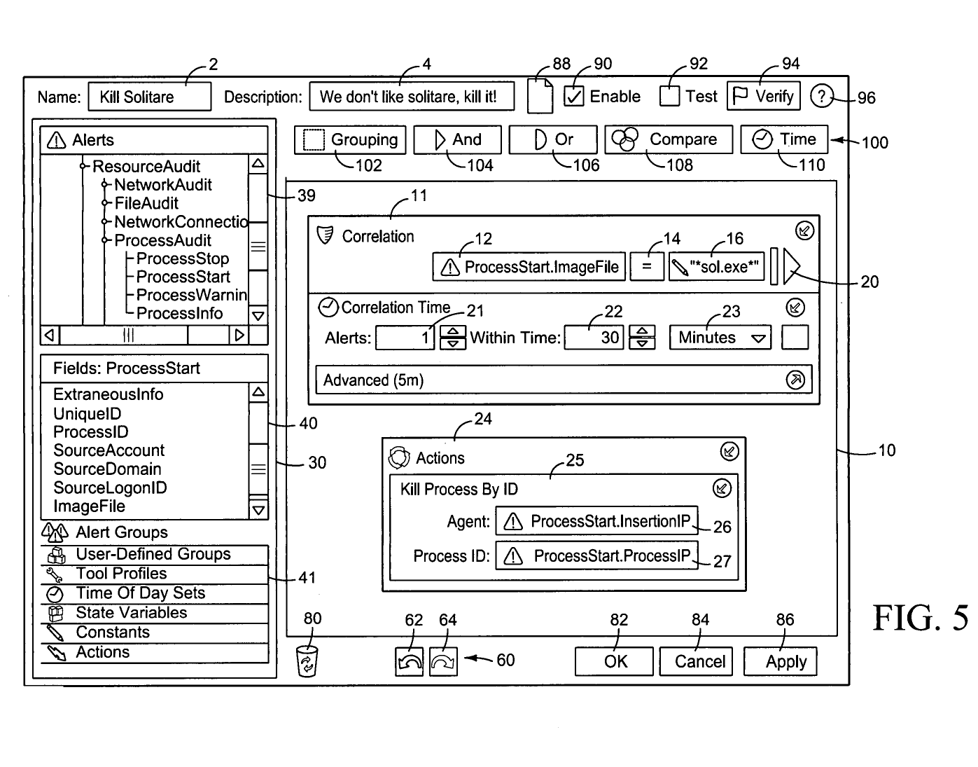

FIG. 5 illustrates an exemplary screen shot of a rule builder interface 500 according to one embodiment of the present application. The rule builder interface 500, which is shown as a single-pane rule construction work surface, comprises a window that can be opened on a computer screen. In the illustrated embodiment, the rule builder interface 500 comprises an expression panel 10, which includes a correlation box 11 and an action box 24, an object chooser panel 30 on the left side of the rule builder interface 500, and an expression object menu bar 100 near the top of the rule builder interface 500. In some embodiments, almost all of the user's interactions with the rule builder interface 500 occur with a computer mouse.

In operation, the expression panel 10 graphically displays the rule as constructed by the user by showing the correlation frame 11 and the action frame 24. The object chooser panel 30 presents the user with building blocks, such as alert events and actions, that the user can use to construct the rules. The expression panel 10 comprises both a drop target for adding objects to the rule from the object chooser panel 30 and expression object menu bar 100, and a drag source for ordering objects or throwing objects away from the rule and into the trash can 80.

The user can choose to begin building a rule from scratch by selecting a New Rule option from an associated application menu. The user can give the rule a name 2, a short description 4, and a long description by clicking on the blank paper button 88. The verify button 96 enables the user to check whether he or she has created a valid rule, meaning that the correlations function together logically and the designated action(s) will take place when the correlation criteria are satisfied. The enable rule checkbox 90 may be used to designate that a rule is operational and will perform the correlation and action tasks that have been defined. The test rule checkbox 92, when used in conjunction with the enable checkbox may be used to designate a rule that will perform the correlation defined, but none of the associated actions. The user can open the help frame by clicking on the help icon 96.

The disposition toolbar 505 at the bottom of the rule builder interface 500 includes a trash can 80, an undo button 62, a redo button 64, an OK button 82, a cancel button 84, and an apply button 86. The trash can button 80 can be used to dispose of unwanted rule components by dragging the components from the expression panel 10 into the trash can 80. Clicking the undo button 62 undoes the last action that was subject to an undo, and can undo up to a selected maximum number of actions, such as about twenty actions. The redo button 64 redoes the last action, and can redo up to a selected maximum number of actions, such as about twenty actions. The apply button 86 saves changes that have been made to the rule. The cancel button 84 cancels any changes that have been made to a rule since the last time the apply button 86 was clicked; in other words, the cancel button 84 returns the rule to the state that the rule was in the last time the rule was saved. The OK button 82 saves changes that have been made to the rule and closes the rule builder.

Object Chooser Panel

The object chooser panel 30 presents in groups the objects that can be included in a rule. The objects in the object chooser panel 30 are drag sources, and may be dragged from the object chooser panel 30 to the expression panel 10. The user applies the building blocks from the object chooser panel 30 to the correlation frame 11 or the action frame 24 via a drag-and-drop interface. In some embodiments, the following types of objects are available from the object chooser panel 30, shown in the type panel 41: ALERTS, ALERT FIELDS, ALERT GROUPS, ALERT GROUP FIELDS, USER-DEFINED GROUPS, TOOL PROFILES, TIME OF DAY SETS, STATE VARIABLES, CONSTANTS, and ACTIONS.

The ALERTS list opens a tree in the group box 39 that displays the computer's alert messages. The group box 39 organizes these alerts into a hierarchical tree. Once an alert has been selected from the group box 39, the field box 40 displays the specific ALERT FIELDS that apply to the selected alert, as shown in FIG. 5, that can be selected and dragged into the correlation box 11.

The ALERT GROUPS list displays preconfigured groups of alerts that the user can use to initiate a particular rule. The group box 39 lists the names of the alert groups. The field box 40 lists specific ALERT GROUP FIELDS that can be selected and dragged into the correlation box 11.

The USER-DEFINED GROUPS list displays preconfigured user-defined groups, which comprise groups of preferences used in policies and alert filters that allow a user to match, include, or exclude events, information, or data fields based on their membership in a particular group. User-defined groups can be used in policies for choosing which events to include or to ignore.

The TOOL PROFILES list displays the different tool profiles available. The tool profiles comprise groups of agents that have common tool configurations, and can be used to have policies and filters include or exclude the agents associated with a particular profile.

The TIME OF DAY SETS list displays the available hour sets. Hour sets are specific groups of hours that can be associated with policies, and allow the policies to take different actions at different times of day.

The STATE VARIABLES list displays the available state variables. The group box 39 lists the names of the state variables, and the field box 40 lists the specific fields that apply to the state variable selected from the group box 39.

The CONSTANTS list displays the types of constants that alert fields, alert group fields, or user defined groups can use for comparing log data. In some embodiments the constants may be defined as text, number, or time. Other embodiments may include additional constants such as IP Address or Subnet and the expression panel fully supports the use of additional defined constants.

The ACTIONS list displays the active responses that a rule can initiate, such as sending an email message, sending a pager message, or blocking an internet protocol address.

Expression Object Menu Bar

The expression object menu bar 100 stores fundamental pieces that make up a rule. The objects in the expression object menu bar 100, like the objects in the object chooser panel 30, are drag sources. Unlike the objects in the object chooser panel 30, the fundamental pieces in the expression object menu bar 100 are non-specific to any type of data. These fundamental pieces are relational terms, which can be applied to the correlation frame 11 to construct correlation criteria via a drag-and-drop interface.

The expression object menu bar 100 includes a GROUPING button 102, an AND button 104, an OR button 106, a COMPARE button 108, and a TIME button 110. These buttons are used by dragging them from the expression object menu bar 100 to the correlation box 11. The GROUPING button 102 is used to insert a new correlation box 11 where expressions can be dropped to provide for independent evaluation of the expressions using either the main correlation time or an independently assigned correlation time The AND button 104 is used to specify that two or more alert events or components or groups must occur together before the rule applies. The OR button 106 is used to specify that any one of two or more correlations or groups can occur before the rule applies. The COMPARE button 108 may be used to insert a new expression component which can be completed with left field, right field and operator components. The TIME button 110 lets the user assign a correlation frequency and advanced threshold fields to a group correlation box.

Expression Panel

The expression panel 10 comprises a workspace where rules are constructed. As shown in FIG. 5, the expression panel 10 comprises a correlation box 11 and an action box 24. The correlation box 11 is used to configure correlations between groups of alert events and related components. The user can coordinate multiple alert events and related components into a set of conditions that will prompt the computer or network to issue a particular active response.

Correlation Box

Rules may be configured in the correlation box 11 as follows. An alert dragged from the object chooser panel 30 onto the left field 12 of the correlation box 11 results in a single expression or correlation statement using the EXISTS operator. This can be toggled between EXISTS and NOT EXISTS to detect the presence or absence of the selected alert. A field associated with an alert can be dragged from the object chooser panel 30 onto the left field 12 of the correlation box 11. An expression is displayed in the correlation box 11, and comprises one row of left field 12, operator 14, and, when the operator is not set to EXISTS or NOT EXISTS, the right field 16. GROUPING button 102 can be used to insert nested correlation boxes or groups 18 into the correlation box 11 that have the same properties of the correlation box 11 and will share the correlation box 11 time and frequency values unless a specific time component is placed inside the group 18. The AND button 104 or the OR button 106 can be dragged from the expression object menu bar 100 into the group 18 to determine the relationship between the elements or expressions inside the group 18, which determines whether either or both expressions must be true for the rule to be satisfied.

The left field 12 can be filled with a building block dragged-and-dropped from the object chooser panel 30. In some embodiments, the types of building blocks available to be dragged-and-dropped from the object chooser panel 30 include ALERT, ALERT GROUP, TEXT ALERT FIELD, TIME ALERT FIELD, NUMBER ALERT FIELD, TEXT ALERT GROUP FIELD, TIME ALERT GROUP FIELD, NUMBER ALERT GROUP FIELD, TEXT STATE VARIABLE, TIME STATE VARIABLE, NUMBER STATE VARIABLE, TEXT CONSTANT, NUMBER CONSTANT, and TIME CONSTANT.

The type of operator can be chosen by right-clicking the operator icon 14 and selecting from a list of possible operators. The type of operator may also be chosen by left-clicking on the operator icon 14 to iterate through the list of possible operators. In some embodiments, the available operators include EXISTS, NOT EXISTS, IS CONTAINED IN, IS NOT CONTAINED IN, =, <>, >, >=, <, and <=.

The EXISTS and NOT EXISTS operators are available when the left field 12 is filled by either an alert or an alert group, and in those cases EXISTS and NOT EXISTS may be the only operators available. Additionally, in those cases, the right field 16 may not be available, because these operators do not compare the value of the left field 12 to any other value. In other cases, the right field 16 is typically available.

The right field 16 can be filled with building blocks that are dragged-and-dropped from the object chooser panel 30. In some embodiments, the building blocks available to be dragged-and-dropped from the object chooser panel 30 to the right field include TEXT ALERT FIELD, TEXT ALERT GROUP FIELD, TEXT STATE VARIABLE FIELD, TEXT CONSTANT, USER DEFINED GROUP, TOOL PROFILE, TIME ALERT FIELD, TIME ALERT GROUP FIELD, TIME STATE VARIABLE FIELD, TIME CONSTANT, TIME OF DAY, NUMBER ALERT FIELD, NUMBER ALERT GROUP FIELD, NUMBER STATE VARIABLE FIELD, and NUMBER CONSTANT.

Not all operators and right-hand building blocks are available for each filling of the left field 12; the available operators 14 depend on what type of field fills the left field 12. In addition, the types of fields available to fill the right field 16 depends on both the type of field filling the left field 12 and the chosen operator.

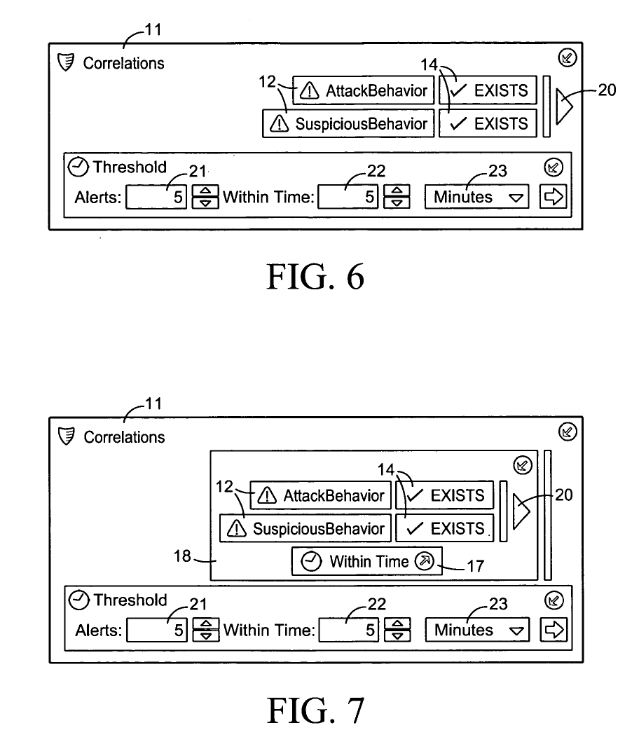

FIG. 6 illustrates an exemplary embodiment of the correlation box 11 with the operator icons 14 displaying EXISTS. As discussed above, because the operators are set to EXISTS, the right fields 16 are not available. The two left fields 12, which display the alerts “AttackBehavior” and “SuspiciousBehavior,” are related by the AND icon 20. Because the AttackBehavior and SuspiciousBehavior alerts are related by the AND icon 20, both an attack alert and a suspicious alert must occur for the correlation to be satisfied.

The correlation time box 13 at the bottom of the correlation box 11 establishes an allowable frequency and time span in which the correlation events must occur before the rule applies. The allowable frequency and time span are established by setting a minimum threshold of correlations that must be satisfied within a specified time for the rule to be satisfied. The correlation time box 13 comprises a threshold number 21 that can be increased or decreased in selected increments (such as one) by clicking the adjacent up and down buttons. The correlation time box 13 further comprises a threshold time 22 that can be increased or decreased in selected increments (such as one) by clicking the adjacent up and down buttons. The correlation time box 13 further comprises a time units button 23 that determines the time units represented by the number in the threshold time 22. In the illustrated embodiment, the time units button can be set to seconds, minutes, hours, or days.

In the example shown in FIG. 6, five correlations of both an AttackBehavior alert existing and a SuspiciousBehavior alert existing must occur within five minutes for the rule to be satisfied. Thus, if the alerts “Attack, Attack, Attack, Attack, Suspicious” occurred within five minutes, then four correlations would result, because the Suspicious alert would correlate once with each of the four Attack alerts, for a total of four correlations. The rule would not be satisfied, however, because the threshold number 21 is set at five correlations in the illustrated example. However, if the alerts, “Attack, Attack, Attack, Attack, Suspicious, Suspicious,” occurred within five minutes, then eight correlations would result, because the two Suspicious alerts would each correlate once with each of the four Attack alerts, for a total of eight correlations. The rule would then be satisfied four times, once for each correlation that meets or exceeds the threshold number 21, five, within the specified time frame.

FIG. 7 shows an alternative embodiment of the correlation box 11, which is functionally identical to the correlation box 11 shown in FIG. 6. In FIG. 7, placing the two expressions into a group 18 does not functionally change the correlation. Unlike FIG. 6, however, the group 18 inside the correlation box 11 shown in FIG. 7 includes a within time button 17. The within time button 17 can be toggled to either display or hide the correlation time box 13.

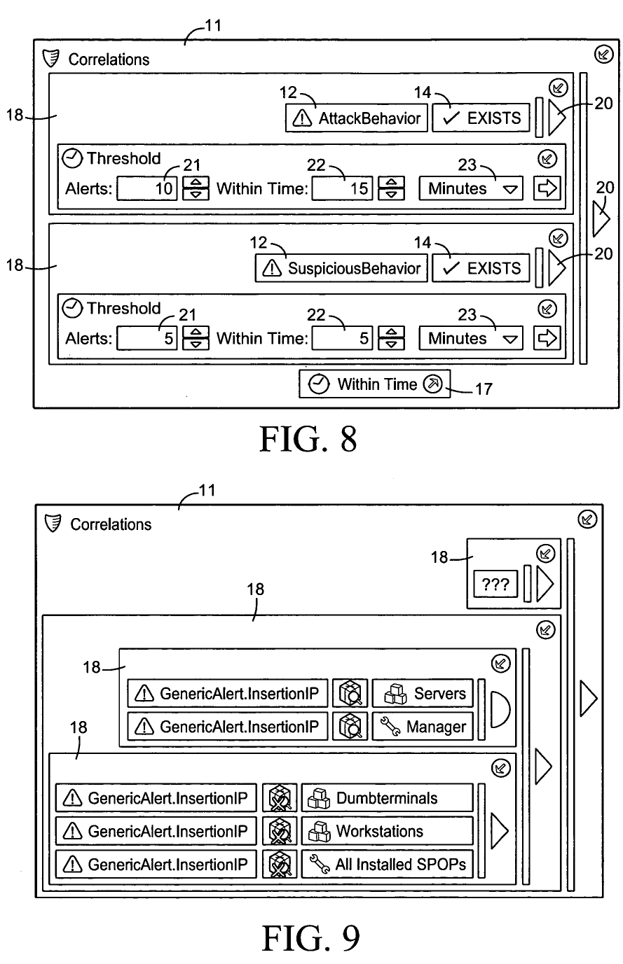

FIG. 8 shows an alternative customization of the rule created within the correlation box 11 using two groups 18 with different settings in the correlation time boxes 13 of each group 18. This example illustrates some of the advantages of nesting groups 18 inside the correlation box 11. In this case, the correlation time box 13 inside the AttackBehavior group 18 indicates that ten AttackBehavior alerts must occur within fifteen minutes for the portion of the correlation inside that group 18 to be satisfied; the correlation time box 13 bar inside the SuspiciousBehavior group 18 indicates that five SuspiciousBehavior alerts must occur within five minutes for the portion of the correlation inside that group 18 to be satisfied. Because the AttackBehavior group 18 and SuspiciousBehavior group 18 are grouped together with an AND icon 20, ten AttackBehavior alerts within fifteen minutes and five SuspiciousBehavior alerts within five minutes must all occur within the time hidden by the within time button 17 for the rule to be satisfied.

The embodiment shown in FIG. 8 has a tightly constrained rule that will result in far fewer matches than the embodiments shown in FIGS. 6 and 7. To warn the user of this type of tight constraint, some embodiments include a verifier to warn the user when he or she produces a correlation with more than one input grouped by an AND condition. If the number of unique input names on the threshold group is greater than one, and the group's operator is the AND operator, then the verifier will warn the user of the hidden “within time” correlation. The verifier uses a specialized function called getGroupInputNames to receive a group node for comparison and examines the children of the group 18.

In some embodiments, each child is treated in one of five ways. If the child is an ALERT EXISTS or ALERT COMPARISON, then the alert name will be added to the input names, but if the alert name already existed in the set then the alert name will not be added. If the child is a group containing a within time (inherited or not inherited), then the group's node name will be added to the input names. If the child is a custom threshold trigger or state variable trigger, then the threshold name will be added to the input names. If the child is a group containing an inline threshold, then the threshold name will be added to the input names. If the child is any other comparison, then the child will be treated as a non-input and not be added to the input names.

FIG. 9 shows another example of nesting groups 18. In this example, the first group 18, with question marks, requires that a COMPARE operator be satisfied. The second group 18, related to the first group 18 by an AND icon 20, contains two nested groups 18. The first nested group 18, which uses the OR icon 20, and in which both expressions use the CONTAINS operator icon 14, requires that GenericAlert.InsertionIP be contained in either the Servers or the Manager. The second nested group 18, which uses the AND icon 20, and in which all three expressions use the NOT CONTAINS operator icon 14, requires that GenericAlert.InsertionIP not be contained in the Dumbterminals, the Workstations, or the Installed SPOPs. Because the first and second nested groups 18 are related by the AND icon 20, the GenericAlert.InsertionIP must be contained in either the Servers or the Manager, but not the Dumbterminals, Workstations, or Installed SPOPs, in order for the correlation created by the second group 18 to be satisfied. Because the second group 18 and the first group 18 are related by the AND icon 20, the correlations of both of these groups 18 must be satisfied for the rule created by this correlation box 11 to be satisfied.

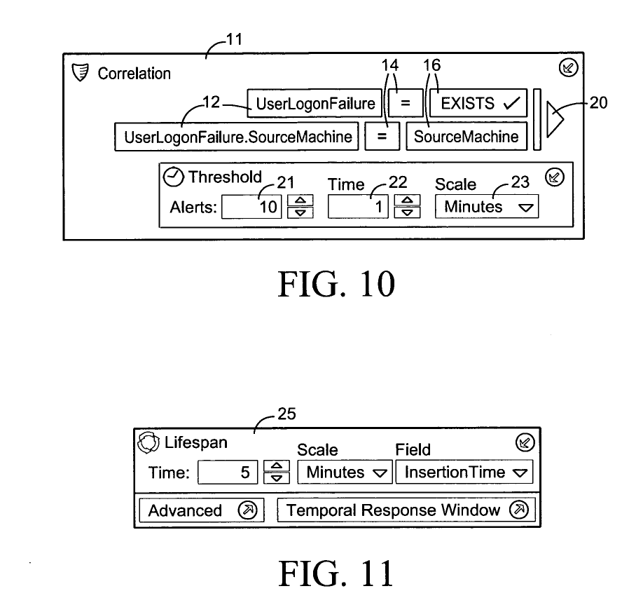

FIG. 10 shows another exemplary embodiment of a correlation box 11 in which the EXISTS operator operates on the alert (UserLogonFailure) that fills the left field 12 of the top expression, making it unnecessary to associate a field in the right field 16 of this expression. The left field 12 of the bottom expression is operated on to require that the left field 12 be equal to the right field 16. As shown, the top expression and the bottom expression are grouped by an AND icon 20. Thus, for the rule to be satisfied, the UserLogonFailure alert must exist, and the UserLogonFailureSourceMachine must be equal to the SourceMachine; these expressions must both be true at least ten times in one minute, as shown by the correlation time box 13.

FIG. 11 shows a lifespan frame 28 which, in some embodiments, substitutes for the threshold time 22 and time units button 23 of the correlation box 11. The lifespan frame 28 enables the user to set the time, scale, and associated field. The lifespan frame 28 also has two optional modes; the first optional mode, activated by clicking on the button labeled “Advanced,” allows the user to expose a selected alert list and individually set the desired field to either insertion or detection. The second optional mode, activated by clicking on the button labeled, “Temporal Response Window,” allows the user to adjust the timeframe within which events will still be considered in scope. Recognizing that events from multiple sources might not have precisely synchronized time stamps and arrive in sequence, this value is used to set the time value plus or minus, or margin of error, within which the correlation should remain active and continue to evaluate alerts.

Action Box

The action box 24, shown in FIG. 5, indicates which action or actions the rule is to execute when the events described in the correlation frame 11 occur. The action box 24 is typically constructed after the correlation box 11 has been constructed. More than one action can be assigned to a rule. The fields in the action box 24 indicate where the action is to be performed, what the action will do, and what the object of the action will be. The action is chosen by first clicking on the “Actions” button on the type panel 41 of the object chooser panel 30, dragging an action from the object chooser panel 30, and dropping the action onto the action box 24. After the selected action has been dropped onto the action box 24, the action box 24 may prompt the user for specific parameters, such as the computer, internet protocol address, port, alert, or user that is to receive the action. These parameters can be supplied by selecting alerts or alert groups and dragging associated fields from the object chooser panel 30 onto the appropriate parameter box in the action box 24. These parameters can also be supplied by selecting user defined groups, tool profiles, state variables or constants from the object chooser panel 30 and dragging onto the appropriate parameter box in the action box 24.

In some embodiments, the user can choose from the following actions: add a new data element to a particular user-defined group, add a user to a specified user group that resides on a particular agent, block an internet protocol address, create a new user account on an agent, create a specified user group on an agent, delete a user account from an agent, delete a user group from a particular agent, detach a USB device on an agent, disable a domain user account on a domain controller agent, disable a local user account on an agent, disable an agent's network address and make the agent unable to connect to the network, disable a Windows machine account that resides on a domain controller agent, enable a domain user account on a domain controller agent, enable a local user account on an agent, enable a Windows machine account that resides on a domain controller agent, escalate potentially irregular audit traffic into security events by creating a new alert with a higher severity, terminate a specified process on an agent by using the process's identification value, terminate a specified process on an agent by referring to the process name, log the user off of an agent, modify a state variable, display an alert as a priority alert, remove a data element from a particular user-defined group, remove a user from a specified user group that resides on a particular agent, reset a user account password on a particular agent, reboot an agent, restart a specified Windows service on an agent, send a preconfigured email message to a predetermined email distribution list, send a pager message to a predetermined list of users, display a popup message to an agent, shut down an agent, start a specified Windows service on an agent, or stop a specified Windows service on an agent.

Although this invention has been described in terms of certain preferred embodiments, other embodiments that are apparent to those of ordinary skill in the art, including embodiments that do not provide all of the features and advantages set forth herein, are also within the scope of this invention. Accordingly, the scope of the present invention is defined only by reference to the appended claims and equivalents thereof.

What is claimed is:

1. A method for constructing a correlation rule on a computer, the method comprising:
viewing a graphical user interface comprising an expression panel, an object chooser panel, and an expression object menu bar,
wherein the expression panel comprises an action box and a correlation box including a left field and an operator icon;
selecting one or more alert events by dragging and dropping the selected alert event(s) from the object chooser panel to the left field of the correlation box;
selecting an operator by clicking on the operator icon of the correlation box;
selecting one or more actions to be performed by the correlation rule by dragging and dropping the selected action(s) from the object chooser panel to the action box of the expression panel.

2. The method of claim 1, further comprising selecting one or more components or component fields by dragging and dropping the selected component(s) or component field(s) from the object chooser panel to a right field of the correlation box.

3. The method of claim 1, further comprising selecting one or more relational terms by dragging and dropping the selected relational term(s) from the expression object menu bar to the expression panel.

4. The method of claim 3, wherein the relational term(s) comprises an icon, text, and a tooltip.

5. The method of claim 1, further comprising requiring that the alert events occur within a specified time span by interacting with a correlation time box.

6. The method of claim 1, wherein the correlation box further comprises a plurality of nested correlation boxes, each nested correlation box comprising a left field and an operator icon.

7. A correlation rule builder comprising:
an object chooser panel displayed via a graphical user interface, the object chooser panel comprising a plurality of alert events;
an expression object menu bar displayed via the graphical user interface, the expression object menu bar comprising a plurality of relational terms; and
an expression panel displayed via the graphical user interface;
wherein the expression panel comprises an action box and a correlation box including a left field and an operator icon; and
wherein the graphical user interface is configured to enable a user to construct correlation rules by dragging and dropping alert events from the object chooser panel to the left field of the correlation box and by dragging and dropping actions from the object chooser panel to the expression panel.

8. The correlation rule builder of claim 7, wherein the objects received by the correlation box are related by objects dragged from the expression object menu bar.

9. The correlation rule builder of claim 7, wherein the graphical user interface is configured to enable a user to select an operator by clicking on the operator icon of the correlation box.

10. The correlation rule builder of claim 7, wherein the correlation box further comprises a right field and wherein the graphical user interface is configured to enable a user to select one or more components or component fields by dragging and dropping the selected component(s) or component field(s) from the object chooser panel to the right field of the correlation box.

11. The correlation rule builder of claim 7, wherein the graphical user interface is configured to enable a user to drag and drop relational terms from the expression object menu bar to the expression panel.

12. The correlation rule builder of claim 11, wherein the relational terms of the expression object menu bar comprise an icon, text, and a tooltip.

13. The correlation rule builder of claim 7, further comprising an undo/redo component comprising a store of information, a store of listeners, a maximum stack size, and a stack pointer.

14. The correlation rule builder of claim 7, wherein the correlation box further comprises a plurality of nested correlation boxes, each nested correlation box comprising a left field and an operator icon.

15. A machine readable medium comprising machine readable instructions for causing a computer to perform a method for constructing a correlation rule, the method comprising:
displaying a graphical user interface comprising an expression panel, an object chooser panel, and an expression object menu bar,
wherein the expression panel comprises an action box and a correlation box including a left field and an operator icon;
enabling a user to select one or more alert events by dragging and dropping the selected alert event(s) from the object chooser panel to the left field of the correlation box;
enabling a user to select an operator by clicking on the operator icon of the correlation box;
enabling a user to select one or more actions to be performed by the correlation rule by dragging and dropping the selected action(s) from the object chooser panel to the action box of the expression panel.

16. The machine readable medium of claim 15, wherein the method further comprises selecting one or more components or component fields by dragging and dropping the selected component(s) or component field(s) from the object chooser panel to a right field of the correlation box.

17. The machine readable medium of claim 15, wherein the method further comprises selecting one or more relational terms by dragging and dropping the selected relational term(s) from the expression object menu bar to the expression panel.

18. The machine readable medium of claim 17, wherein the relational terms comprise an icon, text, and a tooltip.

19. The machine readable medium of claim 15, wherein:
the correlation box further comprises a correlation time box, and
the method further comprises enabling the user to require that the alert events occur within a specified time span by interacting with the correlation time box.

20. The machine readable medium of claim 15, wherein the correlation box further comprises a plurality of nested correlation boxes, each nested correlation box comprising a left field and an operator icon.
